(19) United States
(12) Patent Application Publication
(10) Pub. No.: US 2025/0089103 A1
(43) Pub. Date: Mar. 13, 2025

(54) TECHNIQUES FOR REDUCING THE PROBABILITY OF COLLISIONS WHEN TRANSMITTING LOW LATENCY DATA USING PREEMPTION

(71) Applicant: NEWRACOM, Inc., Irvine, CA (US)

(72) Inventors: Il-Gu LEE, Seoul (KR); Joonsoo LEE, Seoul (KR); Si-Chan NOH, Seoul (KR); Heejung YU, Daejeon (KR)

(73) Assignee: NEWRACOM, Inc., Irvine, CA (US)

(21) Appl. No.: 18/830,423

(22) Filed: Sep. 10, 2024

Related U.S. Application Data
(60) Provisional application No. 63/581,819, filed on Sep. 11, 2023.

(51) Int. Cl. H04W 74/0833; H04W 28/06

(52) U.S. Cl. CPC H04W 74/085; H04W 28/065

(57) ABSTRACT

An embodiment is method performed by a first wireless device to transmit low latency data using a slotted random access technique. The method includes detecting an end of a fragmented physical layer protocol data unit (PPDU) transmission made by a second wireless device, randomly selecting a slot from a plurality of slots forming a slot window that is to follow a short interframe space (SIFS) interval after the end of the fragmented PPDU transmission, and attempting to transmit low latency data during the randomly selected slot.

### CROSS-REFERENCE TO RELATED APPLICATION

This application claims the benefit of U.S. Provisional Application No. 63/581,819 filed Sep. 11, 2023, which is hereby incorporated by reference.

### TECHNICAL FIELD

The present disclosure generally relates to wireless communications, and more specifically, relates to techniques for reducing the probability of collisions when transmitting low latency data using preemption.

### BACKGROUND

Institute of Electrical and Electronics Engineers (IEEE) 802.11 is a set of standards for implementing wireless local area network communication in various frequencies, including but not limited to the 2.4 gigahertz (GHz), 5 GHZ, 6 GHZ, and 60 GHz bands. These standards define the protocols that enable Wi-Fi devices to communicate with each other. The IEEE 802.11 family of standards has evolved over time to accommodate higher data rates, improved security, and better performance in different environments. Some of the most widely used standards include 802.11a, 802.11b, 802.11g, 802.11n, 802.11ac, and 802.11ax (also known as “Wi-Fi 6”). These standards specify the modulation techniques, channel bandwidths, and other technical aspects that facilitate interoperability between devices from various manufacturers. IEEE 802.11 has played an important role in the widespread adoption of wireless networking in homes, offices, and public spaces, enabling users to connect their devices to the internet and each other without the need for wired connections.

IEEE 802.11be, also known as “Wi-Fi 7”, is the next generation of the IEEE 802.11 family of standards for wireless local area networks. Currently under development, 802.11be aims to significantly improve upon the capabilities of its predecessor, 802.11ax/Wi-Fi 6, by offering even higher data rates, lower latency, and increased reliability. The standard is expected to leverage advanced technologies such as multi-link operation (MLO), which allows devices to simultaneously use multiple frequency bands and channels for enhanced performance and reliability. Additionally, 802.11be will introduce 4096-QAM (Quadrature Amplitude Modulation), enabling higher data rates by encoding more bits per symbol. The standard will also feature improved medium access control (MAC) efficiency, enhanced power saving capabilities, and better support for high-density environments. With these advancements, 802.11be is expected to deliver theoretical maximum data rates of up to 46 gigabits per second (Gbps), making it suitable for bandwidth-intensive applications such as virtual and augmented reality, 8K video streaming, and high-performance gaming. The IEEE 802.11be standard is projected to be finalized by the end of 2024, paving the way for the next generation of Wi-Fi devices and networks.

Wireless networks may support high throughput using techniques such as aggregation, block acknowledgement (ACK), channel/link bonding, and transmission opportunities (TXOPs) that provide contention-free channel access. However, if a particular wireless device obtains a long TXOP, it may occupy the channel for a long period of time, which may result in low latency transmissions (transmissions of low latency data (e.g., emergency data)) being delayed. To address this problem, an inter-PPDU (physical layer protocol data unit) preemption technique can be used. With the inter-PPDU preemption technique, the TXOP holder may divide a large PPDU into multiple smaller PPDUs and transmit the multiple smaller PPDUs with a predefined interframe space (e.g., xIFS) interval between PPDU transmissions during which other wireless devices are allowed to preempt the TXOP holder's transmission. However, if there are multiple wireless devices that wish to transmit low latency data during the same interframe space interval, a collision may occur, which may result in degraded performance (e.g., increased latency due to retransmission).

### BRIEF DESCRIPTION OF THE DRAWINGS

The disclosure will be more fully understood from the detailed description provided below and the accompanying drawings that depict various embodiments of the disclosure. However, these drawings should not be interpreted as limiting the disclosure to the specific embodiments shown; they are provided for explanation and understanding only.

FIG. 1 illustrates an example of a wireless local area network (WLAN) with a basic service set (BSS) that includes multiple wireless devices, in accordance with some embodiments of the present disclosure.

FIG. 2 is a schematic diagram of a wireless device, in accordance with some embodiments of the present disclosure.

FIG. 3A illustrates components of a wireless device configured to transmit data, in accordance with some embodiments of the present disclosure.

FIG. 3B illustrates components of a wireless device configured to receive data, in accordance with some embodiments of the present disclosure.

FIG. 4 illustrates interframe space (IFS) relationships, in accordance with some embodiments of the present disclosure.

FIG. 5 illustrates a Carrier Sense Multiple Access with Collision Avoidance (CSMA/CA)-based frame transmission procedure, in accordance with some embodiments of the present disclosure.

FIG. 6 illustrates maximum physical layer (PHY) rates for Institute of Electrical and Electronics Engineers (IEEE) 802.11 standards, in accordance with some embodiments of the present disclosure.

FIG. 7 provides a detailed description of fields in Extremely High Throughput (EHT) Physical Protocol Data Unit (PPDU) frames, including their purposes and characteristics, in accordance with some embodiments of the present disclosure.

FIG. 8 illustrates an example of multi-user (MU) transmission in Orthogonal Frequency-Division Multiple Access (OFDMA), in accordance with some embodiments of the present disclosure.

FIG. 9 illustrates an example of an access point sending a trigger frame to multiple associated stations and receiving Uplink Orthogonal Frequency-Division Multiple Access Trigger-Based Physical Protocol Data Units (UL OFDMA TB PPDUs) in response, in accordance with some embodiments of the present disclosure.

FIG. 10 is a diagram showing an example of transmitting low latency data using an inter-PPDU preemption technique, according to some embodiments.

FIG. 11 is a diagram showing a collision occurring when multiple STAs attempt to transmit low latency data using an inter-PPDU preemption technique, according to some embodiments.

FIG. 12 is a diagram showing an example of transmitting low latency data using a slotted random access technique, according to some embodiments.

FIG. 13 is a diagram showing an example of transmitting low latency data using a frequency resource random access technique, where no collisions occur, according to some embodiments.

FIG. 14 is a diagram showing an example of transmitting low latency data using a frequency resource random access technique, where a collision occurs, according to some embodiments.

FIG. 15 is a flowchart of a method for transmitting low latency data using a slotted random access technique, according to some embodiments.

FIG. 16 is a flowchart of a method for transmitting low latency data using a frequency resource random access technique, according to some embodiments.

FIG. 17 is a flowchart of a method for transmitting low latency data using a combination of a slotted random access technique and a frequency resource random access technique, according to some embodiments.

### DETAILED DESCRIPTION

The present disclosure generally relates to wireless communications, and more specifically, relates to techniques for reducing the probability of collisions when transmitting low latency data using preemption.

As mentioned above, when using an inter-PPDU (physical layer protocol data unit) preemption technique, if there are multiple wireless devices that wish to transmit low latency data during the same interframe space interval, a collision may occur, which may result in degraded performance (e.g., increased latency due to retransmission).

A slotted random access technique is described herein that can reduce the probability of collisions when there are multiple wireless devices that wish to transmit low latency data during the same interframe space interval. With the slotted random access technique, a transmission opportunity (TXOP) holder may transmit fragmented PPDUs with a predefined interframe space (xIFS) interval between fragmented PPDU transmissions. Each xIFS may include a slot window that includes a plurality of slots. The slot window may begin following a short interframe space (SIFS) interval after the end of a fragmented PPDU transmission. If a wireless device has low latency data to transmit, the wireless device may randomly select a slot from the plurality of slots and attempt to transmit the low latency data during the randomly selected slot.

Also, a frequency resource random access technique is described herein that can reduce the probability of collisions when there are multiple wireless devices that wish to transmit low latency data during the same interframe space interval. With the frequency resource random access technique, a TXOP holder may transmit fragmented PPDUs in a plurality of subchannels (e.g., using multi-channel bonding methods) with a predefined interframe space (xIFS) interval between fragmented PPDU transmissions. If a wireless device has low latency data to transmit, the wireless device may randomly select a subchannel from the plurality of subchannels and attempt to transmit the low latency data in the randomly selected subchannel following a SIFS interval after the end of a fragmented PPDU transmission.

The slotted random access technique introduces a level of randomness in the time domain of low latency data transmissions, which helps reduce the probability of collisions. The frequency resource random access technique introduces a level of randomness into the frequency domain of low latency transmissions, which helps reduce the probability of collisions. In an embodiment, the slotted random access technique and the frequency resource random access technique can be combined, thereby further reducing the probability of collisions. By reducing the probability of collisions, the throughput in the wireless network can be increased and the latency of low latency transmissions can be reduced in situations where there are multiple wireless devices that have low latency data to transmit.

For purposes of illustration, various embodiments are described herein in the context of wireless networks that are based on IEEE 802.11 standards and using terminology and concepts thereof. Those skilled in the art will appreciate that the embodiments disclosed herein can be modified/adapted for use in other types of wireless networks.

In the following detailed description, only certain embodiments of the present invention have been shown and described, simply by way of illustration. As those skilled in the art would realize, the described embodiments may be modified in different ways, all without departing from the spirit or scope of the present invention. Accordingly, the drawings and description are to be regarded as illustrative in nature and not restrictive. Like reference numerals designate like elements throughout the specification.

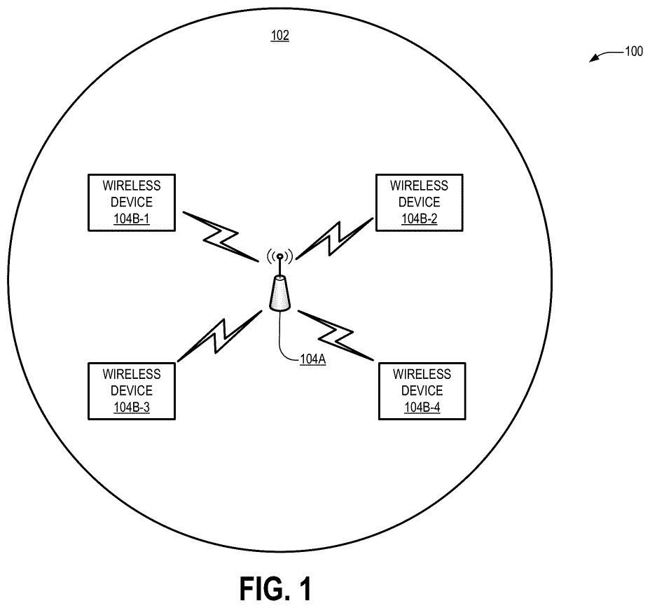

FIG. 1 shows a wireless local area network (WLAN) 100 with a basic service set (BSS) 102 that includes a plurality of wireless devices 104 (sometimes referred to as WLAN devices 104). Each of the wireless devices 104 may include a medium access control (MAC) layer and a physical (PHY) layer according to an IEEE (Institute of Electrical and Electronics Engineers) standard 802.11, including one or more of the amendments (e.g., 802.11a/b/g/n/p/ac/ax/bd/be). In one embodiment, the MAC layer of a wireless device 104 may initiate transmission of a frame to another wireless device 104 by passing a PHY-TXSTART.request (TXVECTOR) to the PHY layer. The TXVECTOR provides parameters for generating and/or transmitting a corresponding frame. Similarly, a PHY layer of a receiving wireless device may generate an RXVECTOR, which includes parameters of a received frame and is passed to a MAC layer for processing.

The plurality of wireless devices 104 may include a wireless device 104A that is an access point (sometimes referred to as an AP station or AP STA) and the other wireless devices 104B₁-104B₄ that are non-AP stations (sometimes referred to as non-AP STAs). Alternatively, all the plurality of wireless devices 104 may be non-AP STAs in an ad-hoc networking environment. In general, the AP STA (e.g., wireless device 104A) and the non-AP STAs (e.g., wireless devices 104B₁-104B₄) may be collectively referred to as STAs. However, for case of description, only the non-AP STAs may be referred to as STAs unless the context indicates otherwise. Although shown with four non-AP STAs (e.g., the wireless devices 104B₁-104B₄), the WLAN 100 may include any number of non-AP STAs (e.g., one or more wireless devices 104B).

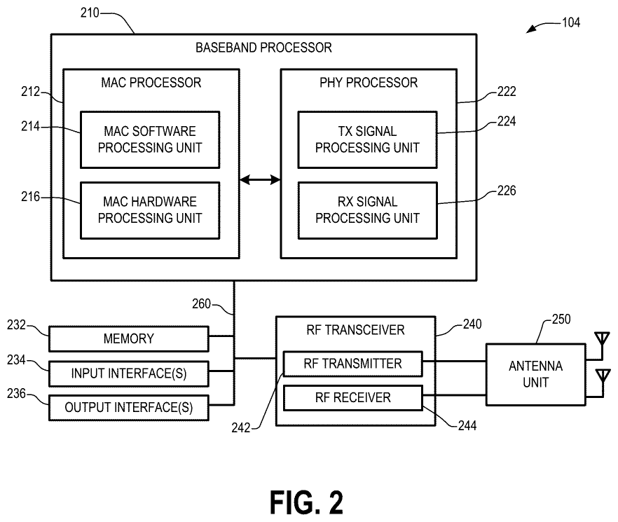

FIG. 2 illustrates a schematic block diagram of a wireless device 104, according to an embodiment. The wireless device 104 may be the wireless device 104A (i.e., the AP of the WLAN 100) or any of the wireless devices 104B₁-104B₄ in FIG. 1. The wireless device 104 includes a baseband processor 210, a radio frequency (RF) transceiver 240, an antenna unit 250, a storage device (e.g., memory device) 232, one or more input interfaces 234, and one or more output interfaces 236. The baseband processor 210, the storage device 232, the input interfaces 234, the output interfaces 236, and the RF transceiver 240 may communicate with each other via a bus 260.

The baseband processor 210 performs baseband signal processing and includes a MAC processor 212 and a PHY processor 222. The baseband processor 210 may utilize the memory 232, which may include a non-transitory computer/machine readable medium having software (e.g., computer/machine programing instructions) and data stored therein.

In an embodiment, the MAC processor 212 includes a MAC software processing unit 214 and a MAC hardware processing unit 216. The MAC software processing unit 214 may implement a first plurality of functions of the MAC layer by executing MAC software, which may be included in the software stored in the storage device 232. The MAC hardware processing unit 216 may implement a second plurality of functions of the MAC layer in special-purpose hardware. However, the MAC processor 212 is not limited thereto. For example, the MAC processor 212 may be configured to perform the first and second plurality of functions entirely in software or entirely in hardware according to an implementation.

The PHY processor 222 includes a transmitting (TX) signal processing unit (SPU) 224 and a receiving (RX) SPU 226. The PHY processor 222 implements a plurality of functions of the PHY layer. These functions may be performed in software, hardware, or a combination thereof according to an implementation.

Functions performed by the transmitting SPU 224 may include one or more of Forward Error Correction (FEC) encoding, stream parsing into one or more spatial streams, diversity encoding of the spatial streams into a plurality of space-time streams, spatial mapping of the space-time streams to transmit chains, inverse Fourier Transform (iFT) computation, Cyclic Prefix (CP) insertion to create a Guard Interval (GI), and the like. Functions performed by the receiving SPU 226 may include inverses of the functions performed by the transmitting SPU 224, such as GI removal, Fourier Transform computation, and the like.

The RF transceiver 240 includes an RF transmitter 242 and an RF receiver 244. The RF transceiver 240 is configured to transmit first information received from the baseband processor 210 to the WLAN 100 (e.g., to another WLAN device 104 of the WLAN 100) and provide second information received from the WLAN 100 (e.g., from another WLAN device 104 of the WLAN 100) to the baseband processor 210.

The antenna unit 250 includes one or more antennas. When Multiple-Input Multiple-Output (MIMO) or Multi-User MIMO (MU-MIMO) is used, the antenna unit 250 may include a plurality of antennas. In an embodiment, the antennas in the antenna unit 250 may operate as a beam-formed antenna array. In an embodiment, the antennas in the antenna unit 250 may be directional antennas, which may be fixed or steerable.

The input interfaces 234 receive information from a user, and the output interfaces 236 output information to the user. The input interfaces 234 may include one or more of a keyboard, keypad, mouse, touchscreen, microphone, and the like. The output interfaces 236 may include one or more of a display device, touch screen, speaker, and the like.

As described herein, many functions of the WLAN device 104 may be implemented in either hardware or software. Which functions are implemented in software and which functions are implemented in hardware will vary according to constraints imposed on a design. The constraints may include one or more of design cost, manufacturing cost, time to market, power consumption, available semiconductor technology, etc.

As described herein, a wide variety of electronic devices, circuits, firmware, software, and combinations thereof may be used to implement the functions of the components of the WLAN device 104. Furthermore, the WLAN device 104 may include other components, such as application processors, storage interfaces, clock generator circuits, power supply circuits, and the like, which have been omitted in the interest of brevity.

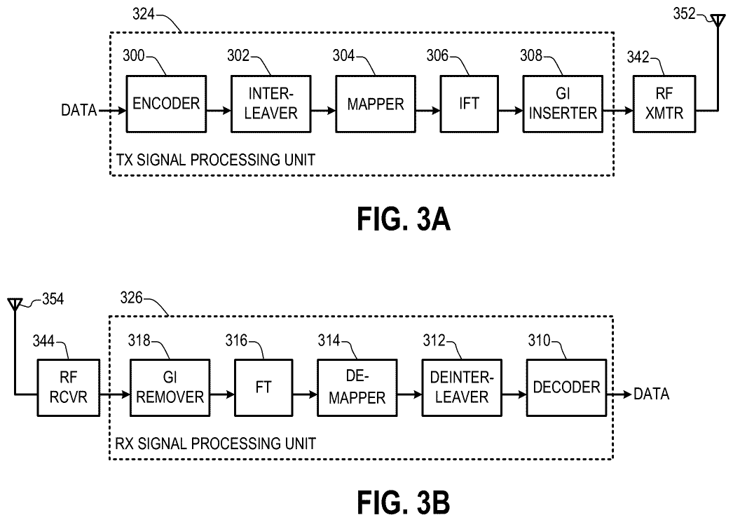

FIG. 3A illustrates components of a WLAN device 104 configured to transmit data according to an embodiment, including a transmitting (Tx) SPU (TxSP) 324, an RF transmitter 342, and an antenna 352. In an embodiment, the TxSP 324, the RF transmitter 342, and the antenna 352 correspond to the transmitting SPU 224, the RF transmitter 242, and an antenna of the antenna unit 250 of FIG. 2, respectively.

The TxSP 324 includes an encoder 300, an interleaver 302, a mapper 304, an inverse Fourier transformer (IFT) 306, and a guard interval (GI) inserter 308.

The encoder 300 receives and encodes input data. In an embodiment, the encoder 300 includes a forward error correction (FEC) encoder. The FEC encoder may include a binary convolution code (BCC) encoder followed by a puncturing device. The FEC encoder may include a low-density parity-check (LDPC) encoder.

The TxSP 324 may further include a scrambler for scrambling the input data before the encoding is performed by the encoder 300 to reduce the probability of long sequences of 0s or 1s. When the encoder 300 performs the BCC encoding, the TxSP 324 may further include an encoder parser for demultiplexing the scrambled bits among a plurality of BCC encoders. If LDPC encoding is used in the encoder, the TxSP 324 may not use the encoder parser.

The interleaver 302 interleaves the bits of each stream output from the encoder 300 to change an order of bits therein. The interleaver 302 may apply the interleaving only when the encoder 300 performs BCC encoding and otherwise may output the stream output from the encoder 300 without changing the order of the bits therein.

The mapper 304 maps the sequence of bits output from the interleaver 302 to constellation points. If the encoder 300 performed LDPC encoding, the mapper 304 may also perform LDPC tone mapping in addition to constellation mapping.

When the TxSP 324 performs a MIMO or MU-MIMO transmission, the TxSP 324 may include a plurality of interleavers 302 and a plurality of mappers 304 according to a number of spatial streams (NSS) of the transmission. The TxSP 324 may further include a stream parser for dividing the output of the encoder 300 into blocks and may respectively send the blocks to different interleavers 302 or mappers 304. The TxSP 324 may further include a space-time block code (STBC) encoder for spreading the constellation points from the spatial streams into a number of space-time streams (NSTS) and a spatial mapper for mapping the space-time streams to transmit chains. The spatial mapper may use direct mapping, spatial expansion, or beamforming.

The IFT 306 converts a block of the constellation points output from the mapper 304 (or, when MIMO or MU-MIMO is performed, the spatial mapper) to a time domain block (i.e., a symbol) by using an inverse discrete Fourier transform (IDFT) or an inverse fast Fourier transform (IFFT). If the STBC encoder and the spatial mapper are used, the IFT 306 may be provided for each transmit chain.

When the TxSP 324 performs a MIMO or MU-MIMO transmission, the TxSP 324 may insert cyclic shift diversities (CSDs) to prevent unintentional beamforming. The TxSP 324 may perform the insertion of the CSD before or after the IFT 306. The CSD may be specified per transmit chain or may be specified per space-time stream. Alternatively, the CSD may be applied as a part of the spatial mapper.

When the TxSP 324 performs a MIMO or MU-MIMO transmission, some blocks before the spatial mapper may be provided for each user.

The GI inserter 308 prepends a GI to each symbol produced by the IFT 306. Each GI may include a Cyclic Prefix (CP) corresponding to a repeated portion of the end of the symbol that the GI precedes. The TxSP 324 may optionally perform windowing to smooth edges of each symbol after inserting the GI.

The RF transmitter 342 converts the symbols into an RF signal and transmits the RF signal via the antenna 352. When the TxSP 324 performs a MIMO or MU-MIMO transmission, the GI inserter 308 and the RF transmitter 342 may be provided for each transmit chain.

FIG. 3B illustrates components of a WLAN device 104 configured to receive data according to an embodiment, including a Receiver (Rx) SPU (RxSP) 326, an RF receiver 344, and an antenna 354. In an embodiment, the RxSP 326, RF receiver 344, and antenna 354 may correspond to the receiving SPU 226, the RF receiver 244, and an antenna of the antenna unit 250 of FIG. 2, respectively.

The RxSP 326 includes a GI remover 318, a Fourier transformer (FT) 316, a demapper 314, a deinterleaver 312, and a decoder 310.

The RF receiver 344 receives an RF signal via the antenna 354 and converts the RF signal into symbols. The GI remover 318 removes the GI from each of the symbols. When the received transmission is a MIMO or MU-MIMO transmission, the RF receiver 344 and the GI remover 318 may be provided for each receive chain.

The FT 316 converts each symbol (that is, each time domain block) into a frequency domain block of constellation points by using a discrete Fourier transform (DFT) or a fast Fourier transform (FFT). The FT 316 may be provided for each receive chain.

When the received transmission is the MIMO or MU-MIMO transmission, the RxSP 326 may include a spatial demapper for converting the respective outputs of the FTs 316 of the receiver chains to constellation points of a plurality of space-time streams, and an STBC decoder for despreading the constellation points from the space-time streams into one or more spatial streams.

The demapper 314 demaps the constellation points output from the FT 316 or the STBC decoder to bit streams. If the received transmission was encoded using LDPC encoding, the demapper 314 may further perform LDPC tone demapping before performing the constellation demapping.

The deinterleaver 312 deinterleaves the bits of each stream output from the demapper 314. The deinterleaver 312 may perform the deinterleaving only when the received transmission was encoded using BCC encoding, and otherwise may output the stream output by the demapper 314 without performing deinterleaving.

When the received transmission is the MIMO or MU-MIMO transmission, the RxSP 326 may use a plurality of demappers 314 and a plurality of deinterleavers 312 corresponding to the number of spatial streams of the transmission. In this case, the RxSP 326 may further include a stream deparser for combining the streams output from the deinterleavers 312.

The decoder 310 decodes the streams output from the deinterleaver 312 or the stream deparser. In an embodiment, the decoder 310 includes an FEC decoder. The FEC decoder may include a BCC decoder or an LDPC decoder.

The RxSP 326 may further include a descrambler for descrambling the decoded data. When the decoder 310 performs BCC decoding, the RxSP 326 may further include an encoder deparser for multiplexing the data decoded by a plurality of BCC decoders. When the decoder 310 performs the LDPC decoding, the RxSP 326 may not use the encoder deparser.

Before making a transmission, wireless devices such as wireless device 104 will assess the availability of the wireless medium using Clear Channel Assessment (CCA). If the medium is occupied, CCA may determine that it is busy, while if the medium is available, CCA determines that it is idle.

The PHY entity for IEEE 802.11 is based on Orthogonal Frequency Division Multiplexing (OFDM) or Orthogonal Frequency Division Multiple Access (OFDMA). In either OFDM or OFDMA Physical (PHY) layers, a STA (e.g., a wireless device 104) is capable of transmitting and receiving Physical Layer (PHY) Protocol Data Units (PPDUs) (also referred to as PLCP (Physical Layer Convergence Procedure) Protocol Data Units) that are compliant with the mandatory PHY specifications. A PHY specification defines a set of Modulation and Coding Schemes (MCS) and a maximum number of spatial streams. Some PHY entities define downlink (DL) and uplink (UL) Multi-User (MU) transmissions having a maximum number of space-time streams (STS) per user and employing up to a predetermined total number of STSs. A PHY entity may provide support for 10 Megahertz (MHz), 20 MHz, 40 MHz, 80 MHZ, 160 MHz, 240 MHz, and 320 MHz contiguous channel widths and support for an 80+80, 80+160 MHz, and 160+160 MHz non-contiguous channel width. Each channel includes a plurality of subcarriers, which may also be referred to as tones. A PHY entity may define signaling fields denoted as Legacy Signal (L-SIG), Signal A (SIG-A), and Signal B (SIG-B), and the like within a PPDU by which some necessary information about PHY Service Data Unit (PSDU) attributes are communicated. The descriptions below, for sake of completeness and brevity, refer to OFDM-based 802.11 technology. Unless otherwise indicated, a station refers to a non-AP STA.

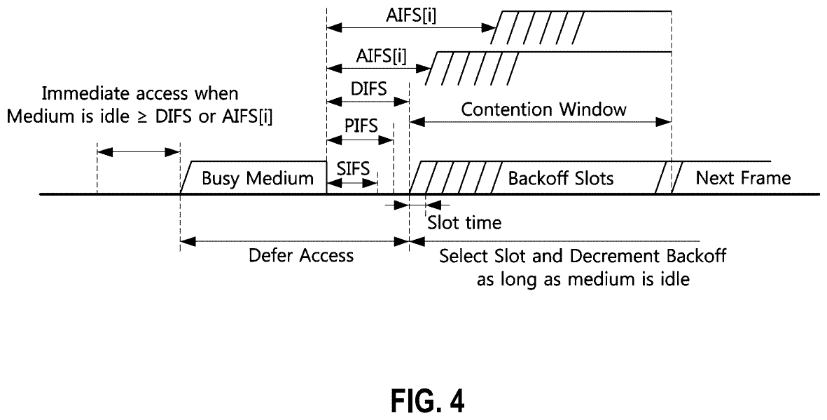

FIG. 4 illustrates Inter-Frame Space (IFS) relationships. In particular, FIG. 4 illustrates a Short IFS (SIFS), a Point Coordination Function (PCF) IFS (PIFS), a Distributed Coordination Function (DCF) IFS (DIFS), and an Arbitration IFSs corresponding to an Access Category (AC) ‘i’ (AIFS[i]). FIG. 4 also illustrates a slot time and a data frame is used for transmission of data forwarded to a higher layer. As shown, a WLAN device 104 transmits the data frame after performing backoff if a DIFS has elapsed during which the medium has been idle.

A management frame may be used for exchanging management information, which is not forwarded to the higher layer. Subtype frames of the management frame include a beacon frame, an association request/response frame, a probe request/response frame, and an authentication request/response frame.

A control frame may be used for controlling access to the medium. Subtype frames of the control frame include a request to send (RTS) frame, a clear to send (CTS) frame, and an acknowledgement (ACK) frame.

When the control frame is not a response frame of another frame, the WLAN device 104 transmits the control frame after performing backoff if a DIFS has elapsed during which the medium has been idle. When the control frame is the response frame of another frame, the WLAN device 104 transmits the control frame after a SIFS has elapsed without performing backoff or checking whether the medium is idle.

A WLAN device 104 that supports Quality of Service (QOS) functionality (that is, a QOS STA) may transmit the frame after performing backoff if an AIFS for an associated access category (AC) (i.e., AIFS[AC]) has elapsed. When transmitted by the QoS STA, any of the data frame, the management frame, and the control frame, which is not the response frame, may use the AIFS[AC] of the AC of the transmitted frame.

A WLAN device 104 may perform a backoff procedure when the WLAN device 104 that is ready to transfer a frame finds the medium busy. The backoff procedure includes determining a random backoff time composed of N backoff slots, where each backoff slot has a duration equal to a slot time and N being an integer number greater than or equal to zero. The backoff time may be determined according to a length of a Contention Window (CW). In an embodiment, the backoff time may be determined according to an AC of the frame. All backoff slots occur following a DIFS or Extended IFS (EIFS) period during which the medium is determined to be idle for the duration of the period.

When the WLAN device 104 detects no medium activity for the duration of a particular backoff slot, the backoff procedure shall decrement the backoff time by the slot time. When the WLAN device 104 determines that the medium is busy during a backoff slot, the backoff procedure is suspended until the medium is again determined to be idle for the duration of a DIFS or EIFS period. The WLAN device 104 may perform transmission or retransmission of the frame when the backoff timer reaches zero.

The backoff procedure operates so that when multiple WLAN devices 104 are deferring and execute the backoff procedure, each WLAN device 104 may select a backoff time using a random function and the WLAN device 104 that selects the smallest backoff time may win the contention, reducing the probability of a collision.

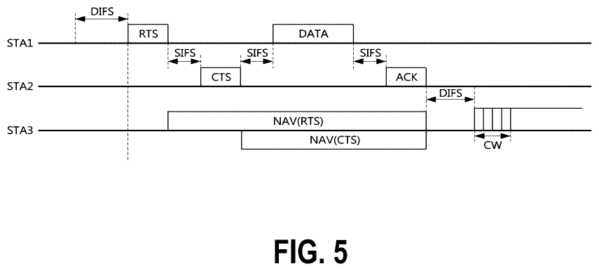

FIG. 5 illustrates a Carrier Sense Multiple Access/Collision Avoidance (CSMA/CA) based frame transmission procedure for avoiding collision between frames in a channel according to an embodiment. FIG. 5 shows a first station STA1 transmitting data, a second station STA2 receiving the data, and a third station STA3 that may be located in an area where a frame transmitted from the STA1 can be received, a frame transmitted from the second station STA2 can be received, or both can be received. The stations STA1, STA2, and STA3 may be WLAN devices 104 of FIG. 1.

The station STA1 may determine whether the channel is busy by carrier sensing. The station STA1 may determine channel occupation/status based on an energy level in the channel or an autocorrelation of signals in the channel, or may determine the channel occupation by using a network allocation vector (NAV) timer.

After determining that the channel is not used by other devices (that is, that the channel is IDLE) during a DIFS (and performing backoff if required), the station STA1 may transmit a Request-To-Send (RTS) frame to the station STA2. Upon receiving the RTS frame, after a SIFS the station STA2 may transmit a Clear-To-Send (CTS) frame as a response to the RTS frame. If Dual-CTS is enabled and the station STA2 is an AP, the AP may send two CTS frames in response to the RTS frame (e.g., a first CTS frame in a non-High Throughput format and a second CTS frame in the HT format).

When the station STA3 receives the RTS frame, it may set a NAV timer of the station STA3 for a transmission duration of subsequently transmitted frames (for example, a duration of SIFS+CTS frame duration+SIFS+data frame duration+SIFS+ACK frame duration) using duration information included in the RTS frame. When the station STA3 receives the CTS frame, it may set the NAV timer of the station STA3 for a transmission duration of subsequently transmitted frames using duration information included in the CTS frame. Upon receiving a new frame before the NAV timer expires, the station STA3 may update the NAV timer of the station STA3 by using duration information included in the new frame. The station STA3 docs not attempt to access the channel until the NAV timer expires.

When the station STA1 receives the CTS frame from the station STA2, it may transmit a data frame to the station STA2 after a SIFS period elapses from a time when the CTS frame has been completely received. Upon successfully receiving the data frame, the station STA2 may transmit an ACK frame as a response to the data frame after a SIFS period clapses.

When the NAV timer expires, the third station STA3 may determine whether the channel is busy using the carrier sensing. Upon determining that the channel is not used by other devices during a DIFS period after the NAV timer has expired, the station STA3 may attempt to access the channel after a contention window elapses according to a backoff process.

When Dual-CTS is enabled, a station that has obtained a transmission opportunity (TXOP) and that has no data to transmit may transmit a CF-End frame to cut short the TXOP. An AP receiving a CF-End frame having a Basic Service Set Identifier (BSSID) of the AP as a destination address may respond by transmitting two more CF-End frames: a first CF-End frame using Space Time Block Coding (STBC) and a second CF-End frame using non-STBC. A station receiving a CF-End frame resets its NAV timer to 0 at the end of the PPDU containing the CF-End frame. FIG. 5 shows the station STA2 transmitting an ACK frame to acknowledge the successful reception of a frame by the recipient.

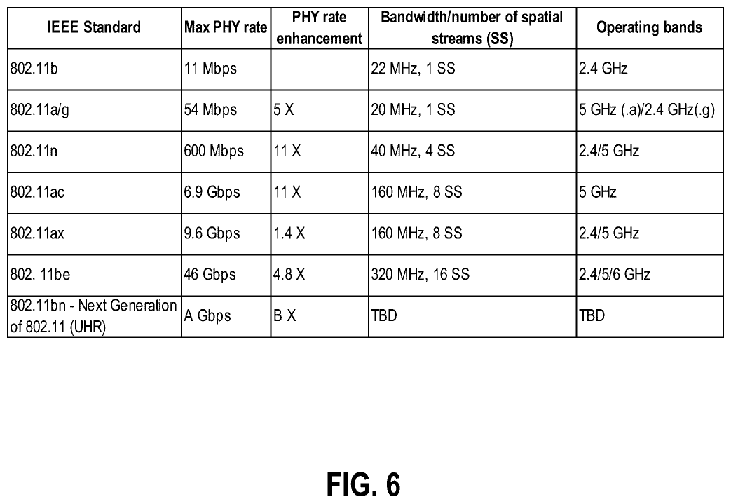

The IEEE 802.11bn (Ultra High Reliability, UHR) working group has been established to address the growing demand for higher peak throughput and reliability in Wi-Fi. As shown in FIG. 6, the peak PHY rate has significantly increased from IEEE 802.11b to IEEE 802.11be (Wi-Fi 7), with the latter focusing on further improving peak throughput. The UHR study group aims to enhance the tail of the latency distribution and jitter to support applications that require low latency, such as video-over-WLAN, gaming, AR, and VR. It is noted that various characteristics of UHR (e.g., max PHY rate, PHY rate enhancement, bandwidth/number of spatial streams, and operating bands) are still to be determined.

The focus of IEEE 802.11be is primarily on WLAN indoor and outdoor operation with stationary and pedestrian speeds in the 2.4, 5, and 6 GHz frequency bands. In addition to peak PHY rate, different candidate features are under discussion. These candidate features include (1) a 320 MHz bandwidth and a more efficient utilization of a non-contiguous spectrum, (2) multi-band/multi-channel aggregation and operation, (3) 16 spatial streams and Multiple Input Multiple Output (MIMO) protocol enhancements, (4) multi-Access Point (AP) Coordination (e.g., coordinated and joint transmission), (5) an enhanced link adaptation and retransmission protocol (e.g., Hybrid Automatic Repeat Request (HARQ)), and (6) adaptation to regulatory rules specific to a 6 GHz spectrum.

The focus of IEEE 802.11bn (UHR) is still under discussion, with candidate features including MLO enhancements (e.g., in terms of increased throughput/reliability and decreased latency), latency and reliability improvements (e.g., multi-AP coordination to support low latency traffic), bandwidth expansion (e.g., to 240, 480, 640 MHZ), aggregated PPDU (A-PPDU), enhanced multi-link single-radio (cMLSR) extensions to AP, roaming improvements, and power-saving schemes for prolonging battery life.

Some features, such as increasing the bandwidth and the number of spatial streams, are solutions that have been proven to be effective in previous projects focused on increasing link throughput and on which feasibility demonstration is achievable.

With respect to operational bands (e.g., 2.4/5/6 GHZ) for IEEE 802.11be, more than 1 GHz of additional unlicensed spectrum is likely to be available because the 6 GHz band (5.925-7.125 GHZ) is being considered for unlicensed usc. This would allow APs and STAs to become tri-band devices. Larger than 160 MHz data transmissions (e.g., 320 MHz or 640 MHZ) could be considered to increase the maximum PHY rate. For example, 320 MHZ or 160+160 MHz data could be transmitted in the 6 GHz band. For example, 160+160 MHz data could be transmitted across the 5 and 6 GHz bands.

In the process of wireless communication, a transmitting station (STA) creates a Physical Layer Protocol Data Unit (PPDU) frame and sends it to a receiving STA. The receiving STA then receives, detects, and processes the PPDU.

The Extremely High Throughput (EHT) PPDU frame encompasses several components. It includes a legacy part, which comprises fields such as the Legacy Short Training Field (L-STF), Legacy Long Training Field (L-LTF), Legacy Signal Field (L-SIG), and Repeated Legacy Signal Field (RL-SIG). These fields are used to maintain compatibility with older Wi-Fi standards.

In addition to the legacy part, the EHT PPDU frame also contains the Universal Signal Field (U-SIG), EHT Signal Field (EHT-SIG), EHT Short Training Field (EHT-STF), and EHT Long Training Field (EHT-LTF). These fields are specific to the EHT standard and are used for various purposes, such as signaling, synchronization, and channel estimation.

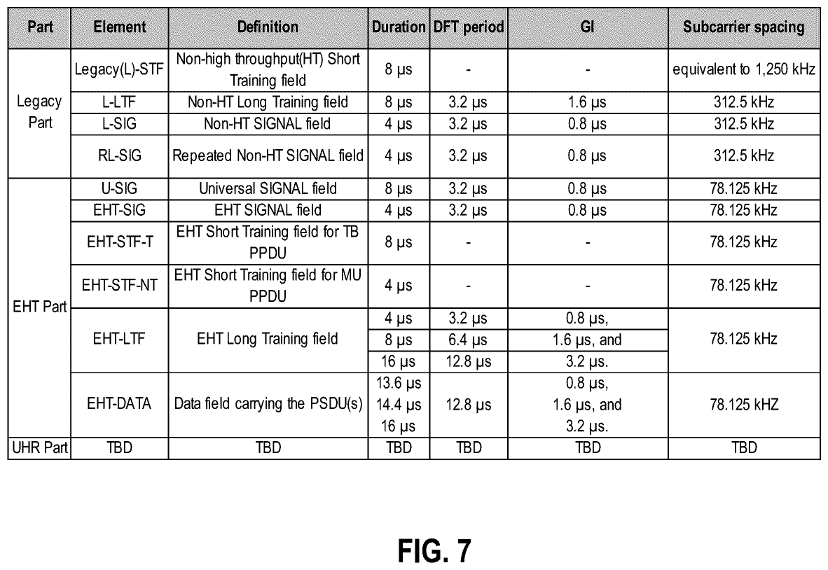

FIG. 7 provides a more detailed description of each field in the EHT PPDU frame, including their purposes and characteristics.

Regarding the Ultra High Reliability (UHR) PPDU, its frame structure is currently undefined and will be determined through further discussions within the relevant working group or study group. This indicates that the specifics of the UHR PPDU are still under development and will be finalized based on the outcomes of future deliberations.

The distributed nature of channel access networks, such as IEEE 802.11 WLANs, makes the carrier sense mechanism useful for ensuring collision-free operation. Each station (STA) uses its physical carrier sense to detect transmissions from other STAs. However, in certain situations, it may not be possible for a STA to detect every transmission. For instance, when one STA is located far away from another STA, it might perceive the medium as idle and start transmitting a frame, leading to collisions. To mitigate this hidden node problem, the network allocation vector (NAV) has been introduced.

As the IEEE 802.11 standard continues to evolve, it now includes scenarios where multiple users can simultaneously transmit or receive data within a basic service set (BSS), such as uplink (UL) and downlink (DL) multi-user (MU) transmissions in a cascaded manner. In these cases, the existing carrier sense and NAV mechanisms may not be sufficient, and modifications or newly defined mechanisms may be required to facilitate efficient and collision-free operation.

For the purpose of this disclosure, MU transmission refers to situations where multiple frames are transmitted to or from multiple STAs simultaneously using different resources. Examples of these resources include different frequency resources in Orthogonal Frequency Division Multiple Access (OFDMA) transmission and different spatial streams in Multi-User Multiple Input Multiple Output (MU-MIMO) transmission. Consequently, downlink OFDMA (DL-OFDMA), downlink MU-MIMO (DL-MU-MIMO), uplink OFDMA (UL-OFDMA), uplink MU-MIMO (UL-MU-MIMO), and OFDMA with MU-MIMO are all considered examples of MU transmission.

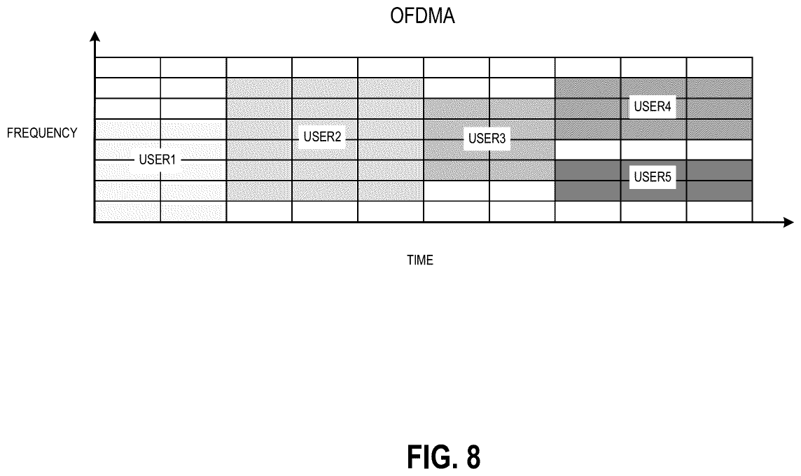

FIG. 8 illustrates an example of multi-user (MU) transmission in Orthogonal Frequency-Division Multiple Access (OFDMA), in accordance with some embodiments of the present disclosure.

In the IEEE 802.11ax and 802.11be specifications, the trigger frame plays a useful role in facilitating uplink multi-user (MU) transmissions. The purpose of the trigger frame is to allocate resources and solicit one or more Trigger-based (TB) Physical Layer Protocol Data Unit (PPDU) transmissions from the associated stations (STAs).

The trigger frame contains information required by the responding STAs to send their Uplink TB PPDUs. This information includes the Trigger type, which specifies the type of TB PPDU expected, and the Uplink Length (UL Length), which indicates the duration of the uplink transmission.

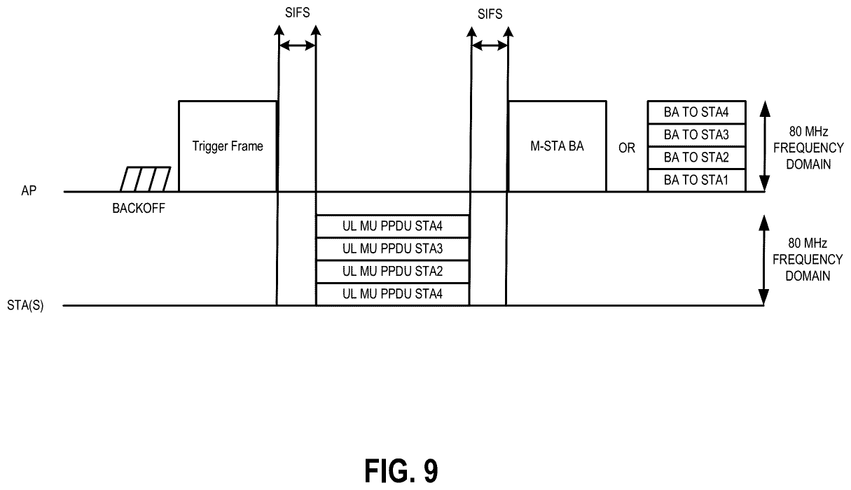

FIG. 9 illustrates an example scenario where an access point (AP) operating in an 80 MHz bandwidth environment sends a Trigger frame to multiple associated STAs. Upon receiving the Trigger frame, the STAs respond by sending their respective Uplink Orthogonal Frequency Division Multiple Access (UL OFDMA) TB PPDUs, utilizing the allocated resources within the specified 80 MHz bandwidth.

After successfully receiving the UL OFDMA TB PPDUs, the AP acknowledges the STAs by sending an acknowledgement frame. This acknowledgement can be in the form of an 80 MHz width multi-STA Block Acknowledgement (Block Ack) or a Block Acknowledgement with a Direct Feedback (DF) OFDMA method. The multi-STA Block Ack allows the AP to acknowledge multiple STAs simultaneously, while the Block Ack with DF OFDMA enables the AP to provide feedback to the STAs using the same OFDMA technique employed in the uplink transmission.

The trigger frame is a useful component in enabling efficient uplink MU transmissions in IEEE 802.11ax and 802.11be networks, by allocating resources and coordinating the uplink transmissions from multiple STAs within the same bandwidth.

Wireless network systems can rely on retransmission of media access control (MAC) protocol data units (MPDUs) when the transmitter (TX) does not receive an acknowledgement from the receiver (RX) or MPDUs are not successfully decoded by the receiver. Using an automatic repeat request (ARQ) approach, the receiver discards the last failed MPDU before receiving the newly retransmitted MPDU. With requirements of enhanced reliability and reduced latency, the wireless network system can evolve toward a hybrid ARQ (HARQ) approach.

There are two methods of HARQ processing. In a first type of HARQ scheme, also referred to as chase combining (CC) HARQ (CC-HARQ) scheme, signals to be retransmitted are the same as the signals that previously failed because all subpackets to be retransmitted use the same puncturing pattern. The puncturing is needed to remove some of the parity bits after encoding using an error-correction code. The reason why the same puncturing pattern is used with CC-HARQ is to generate a coded data sequence with forward error correction (FEC) and to make the receiver use a maximum-ratio combining (MRC) to combine the received, retransmitted bits with the same bits from the previous transmission. For example, information sequences are transmitted in packets with a fixed length. At a receiver, error correction and detection are carried out over the whole packet. However, the ARQ scheme may be inefficient in the presence of burst errors. To solve this more efficiently, subpackets are used. In subpacket transmissions, only those subpackets that include errors need to be retransmitted.

Since the receiver uses both the current and the previously received subpackets for decoding data, the error probability in decoding decreases as the number of used subpackets increases. The decoding process passes a cyclic redundancy check (CRC) and ends when the entire packet is decoded without error or the maximum number of subpackets is reached. In particular, this scheme operates on a stop-and-wait protocol such that if the receiver can decode the packet, it sends an acknowledgement (ACK) to the transmitter. When the transmitter receives an ACK successfully, it terminates the HARQ transmission of the packet. If the receiver cannot decode the packet, it sends a negative acknowledgement (NAK) to the transmitter and the transmitter performs the retransmission process.

In a second type of HARQ scheme, also referred to as an incremental redundancy (IR) HARQ (IR-HARQ) scheme, different puncturing patterns are used for each subpacket such that the signal changes for each retransmitted subpacket in comparison to the originally transmitted subpacket. IR-HARQ alternatively uses two puncturing patterns for odd numbered and even numbered transmissions, respectively. The redundancy scheme of IR-HARQ improves the log likelihood ratio (LLR) of parity bit(s) in order to combine information sent across different transmissions due to requests and lowers the code rate as the additional subpacket is used. This results in a lower error rate of the subpacket in comparison to CC-HARQ. The puncturing pattern used in IR-HARQ is indicated by a subpacket identity (SPID) indication. The SPID of the first subpacket may always be set to 0 and all the systematic bits and the punctured parity bits are transmitted in the first subpacket. Self-decoding is possible when the receiving signal-to-noise ratio (SNR) environment is good (i.e., a high SNR). In some embodiments, subpackets with corresponding SPIDs to be transmitted are in increasing order of SPID but can be exchanged/switched except for the first SPID.

AP coordination has been considered as a potential technology to improve WLAN system throughput in the IEEE 802.11be standard and is still being discussed in the IEEE 802.11bn (UHR) standard. To support various AP coordination schemes, such as coordinated beamforming, OFDMA, TDMA, spatial reuse, and joint transmission, a predefined mechanism for APs is necessary.

In the context of coordinated TDMA (C-TDMA), the AP that obtains a transmit opportunity (TXOP) is referred to as the sharing AP. This AP initiates the AP coordination schemes to determine the AP candidate set by sending a frame, such as a Beacon frame or probe response frame, which includes information about the AP coordination scheme capabilities. The AP that participates in the AP coordination schemes after receiving the frame from the sharing AP is called the shared AP. The sharing AP is also known as the master AP or coordinating AP, while the shared AP is referred to as the slave AP or coordinated AP.

The operation of various AP coordination schemes has been discussed in the IEEE 802.11be and UHR standards:

Coordinated Beamforming (C-BF): Multiple APs transmit on the same frequency resource by coordinating and forming spatial nulls, allowing for simultaneous transmission from multiple APs.

Coordinated OFDMA (C-OFDMA): APs transmit on orthogonal frequency resources by coordinating and splitting the spectrum, enabling more efficient spectrum utilization.

Joint Transmission (JTX): Multiple APs transmit jointly to a given user simultaneously by sharing data between the APs.

Coordinated Spatial Reuse (C-SR): Multiple APs or STAs adjust their transmit power to reduce interference between APs.

By implementing these AP coordination schemes, WLAN systems can improve their overall throughput and efficiency by leveraging the cooperation between multiple APs.

When an AP obtains a TXOP, it may transmit a long PPDU to a STA (STA1), and thus occupy the channel or link for a long period of time. However, if another STA (STA2) has low latency data to transmit, STA2 cannot transmit the low latency data until the TXOP is over, resulting in increased latency for STA2's low latency data transmission. An inter-PPDU based preemption technique can be used to reduce the latency of STA2's low latency data transmission.

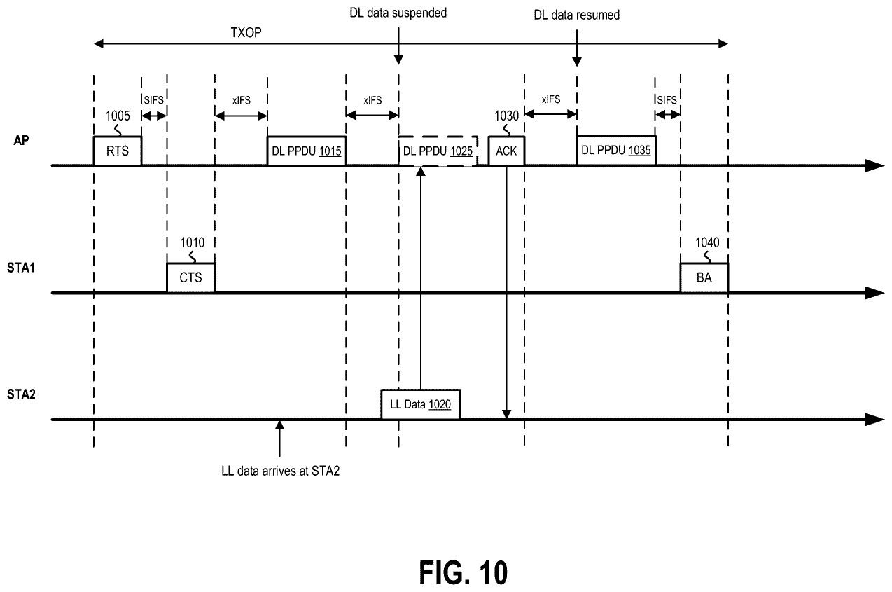

FIG. 10 is a diagram showing an example of transmitting low latency data using an inter-PPDU preemption technique, according to some embodiments.

As shown in the diagram, the AP may transmit a request-to-send (RTS) frame 1005 to STA1. Following a SIFS interval after receiving RTS frame 1005, STA1 may transmit a clear-to-send (CTS) frame 1010 to the AP. The duration of a SIFS interval may be predefined (e.g., in a wireless networking standard). The exchange of the RTS frame 1005 and the CTS frame 1010 may establish a TXOP for the AP. The AP is said to be the TXOP holder in this scenario.

With the inter-PPDU preemption technique, the AP may divide a large PPDU into multiple smaller PPDUs and transmit the multiple smaller PPDUs with a predefined interframe space interval between PPDU transmissions during which STAs may preempt the AP's transmission. The predefined interframe space interval may be referred to as a xIFS interval. The duration of an xIFS interval may be predefined (e.g., in the wireless networking standard). The smaller PPDUs may be referred to herein as fragmented PPDUs.

Following a xIFS interval after receiving CTS frame 1010, the AP may transmit fragmented downlink (DL) PPDU 1015 to STA1. STA2 may determine that it has low latency data to transmit to the AP while the AP transmits fragmented DL PPDU 1015 (low latency (LL) data arrives at STA2). Accordingly, during the xIFS interval following the AP's transmission of fragmented DL PPDU 1015, STA2 may transmit low latency data frame 1020 that includes the low latency data to the AP, thereby preempting the AP's transmission. Responsive to detecting low latency data frame 1020, the AP may suspend transmission of the next scheduled fragmented DL PPDU 1025 (which is shown in the diagram in dashed lines to indicate that it is not actually transmitted) to receive low latency data frame 1020. If the AP successfully receives low latency data frame 1020, the AP may transmit acknowledgement (ACK) frame 1030 to STA2 to acknowledge successful reception of low latency data frame 1020.

Following a xIFS interval after transmitting ACK frame 1030, the AP may resume transmitting fragmented PPDUs to STA1. For example, the AP may transmit fragmented DL PPDU 1035 to STA1. Fragmented DL PPDU 1035 may include the data that was supposed to be included in fragmented DL PPDU 1025 but that was not transmitted due to the AP's transmission being preempted by STA2. Following a SIFS interval after receiving the last fragmented DL PPDU from the AP, which in this example is fragmented DL PPDU 1035, STA1 may transmit a block ACK (BA) frame 1040 to the AP to acknowledge successful reception of all of the fragmented PPDUs.

Thus, if STA2 has low latency data to transmit to the AP, STA2 may transmit a low latency data frame that includes the low latency data to the AP during a xIFS interval between fragmented PPDU transmissions. In particular, STA2 may transmit the low latency data frame following a SIFS interval after the end of a fragmented PPDU transmission. The xIFS interval may be longer than the SIFS interval so the AP may detect the low latency data frame and suspend the next scheduled fragmented PPDU transmission to receive the low latency data frame from STA2. Once the AP has received the low latency data from STA2 and transmitted an ACK frame to STA2, the AP may resume transmission of fragmented PPDUs to STA1 following a xIFS interval after transmission of the ACK frame.

In the example situation shown in FIG. 10 and described above, there is only one STA (STA2) that attempts to transmit low latency data during a particular xIFS interval between fragmented PPDU transmissions. However, it is possible for multiple STAs to have low latency data to transmit and they may attempt to transmit their low latency data during the same xIFS interval between fragmented PPDU transmissions, which may result in the occurrence of a collision.

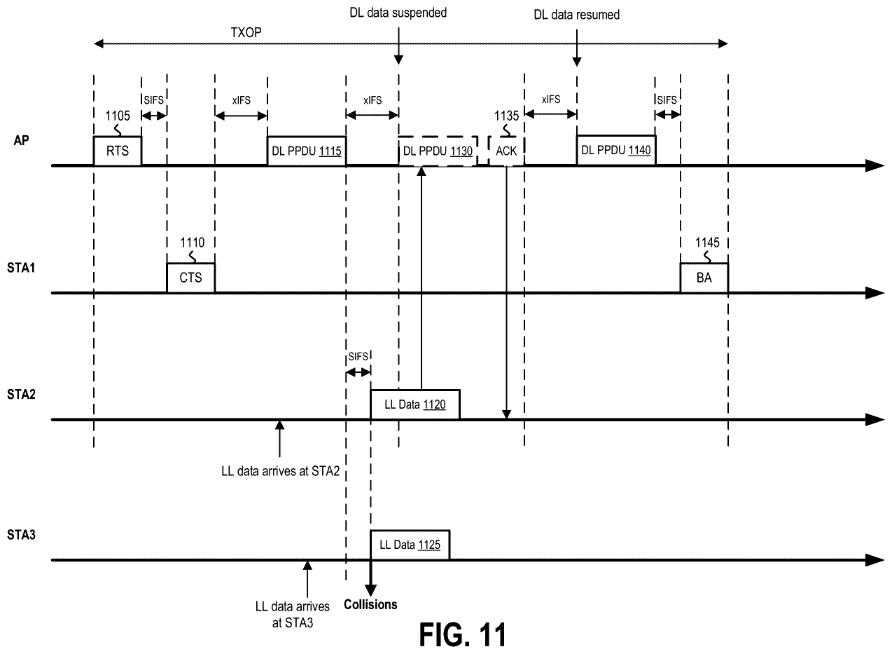

FIG. 11 is a diagram showing a collision occurring when multiple STAs attempt to transmit low latency data using an inter-PPDU preemption technique, according to some embodiments.

As shown in the diagram, the AP may transmit a RTS frame 1105 to STA1. Following a SIFS interval after receiving RTS frame 1105, STA1 may transmit a CTS frame 1110 to the AP. The exchange of the RTS frame 1105 and the CTS frame 1110 may establish a TXOP for the AP. The AP is said to be the TXOP holder in this scenario.

Following a xIFS interval after receiving CTS frame 1110, the AP may transmit fragmented DL PPDU 1115 to STA1.

STA2 may determine it has low latency data to transmit to the AP (LL data arrives at STA2) while the AP is transmitting fragmented DL PPDU 1115. Also, STA3 may also determine that it has low latency data to transmit to the AP (LL data arrives at STA3) while the AP is transmitting fragmented DL PPDU 1115. As a result, following a SIFS interval after the AP finishes transmitting fragmented DL PPDU 1115, both STA2 and STA3 may simultaneously attempt to transmit low latency data frames that includes their respective low latency data (low latency data frame 1120 and low latency data frame 1125, respectively) to the AP. The AP may suspend its transmission of the next scheduled fragmented DL PPDU 1130 to receive the low latency data frames, but the AP may not be able to successfully receive either data frame due to the occurrence of a collision. As a result, the AP may not transmit an ACK frame 1135 to either STA2 or STA3 (ACK frame 1135 is shown in dashed lines to indicate that it is not transmitted).

Following a xIFS interval after an ACK timeout occurs, the AP may resume transmitting fragmented PPDUs to STA1. For example, the AP may transmit fragmented DL PPDU 1140 to STA1. Fragmented DL PPDU 1140 may include the data that was supposed to be included in fragmented DL PPDU 1130 but that was not transmitted due to the AP's transmission being preempted by STA2 and STA3. Following a SIFS interval after receiving the last fragmented DL PPDU from the AP, which in this example is fragmented DL PPDU 1140, STA1 may transmit a block ACK (BA) frame 1145 to the AP if STA1 has successfully received all of the fragmented PPDUs.

The occurrence of the collision decreases the throughput in the wireless network and increases latency of low latency data transmissions. Thus, there is a need for a way to avoid collisions or reduce the probability of collisions when multiple STAs wish to transmit low latency data using an inter-PPDU preemption technique.

One way to address the collision problem is to protect the low latency transmission by exchanging RTS/CTS frames prior to the low latency transmission. Low latency traffic is characterized by intermittent occurrence and short transmission duration. While the RTS/CTS frame exchange is effective for large transmissions, it adds too much overhead for intermittent and short low latency transmissions. Also, the RTS/CTS frames may also have a collision problem.

Another way to address the collision problem is to use a contention-based medium access mechanism with random backoff. When there is a collision, STAs may perform a random backoff before attempting to retransmit its low latency data. However, in order to enable a random backoff mechanism, the duration of xIFS between fragmented PPDU transmissions has to be very long, which increases transmission overhead and reduces throughput.

A slotted random access technique is described herein that can reduce the probability of collisions when using an inter-PPDU preemption technique. With the slotted random access technique, an interframe space interval between fragmented PPDU transmissions may include a slot window that includes a plurality of slots (N slots). The xIFS interval between fragmented PPDU transmissions should be longer than the combined duration of SIFS and the duration of the slot window (i.e., xIFS>SIFS+N*(duration of a slot), where N is the number of slots in a slot window). The duration of a slot may be the minimum duration that is needed for carrier sensing. The slot window may begin following a SIFS interval after the end of a fragmented PPDU transmission. With the slotted random access technique, if a wireless device has low latency data to transmit, the wireless device may randomly select a slot from the plurality of slots and attempt to transmit the low latency data during the randomly selected slot.

The number of slots in a time window (N) may be adjusted or determined in consideration of network conditions (e.g., based on the number of STAs in the network, how often low latency data transmissions are expected to occur, etc.). A STA that loses low latency data transmission priority during a xIFS interval (e.g., because another STA randomly selects an earlier slot and gets transmission priority) may attempt to retransmit the low latency data using random access during the next xIFS interval.

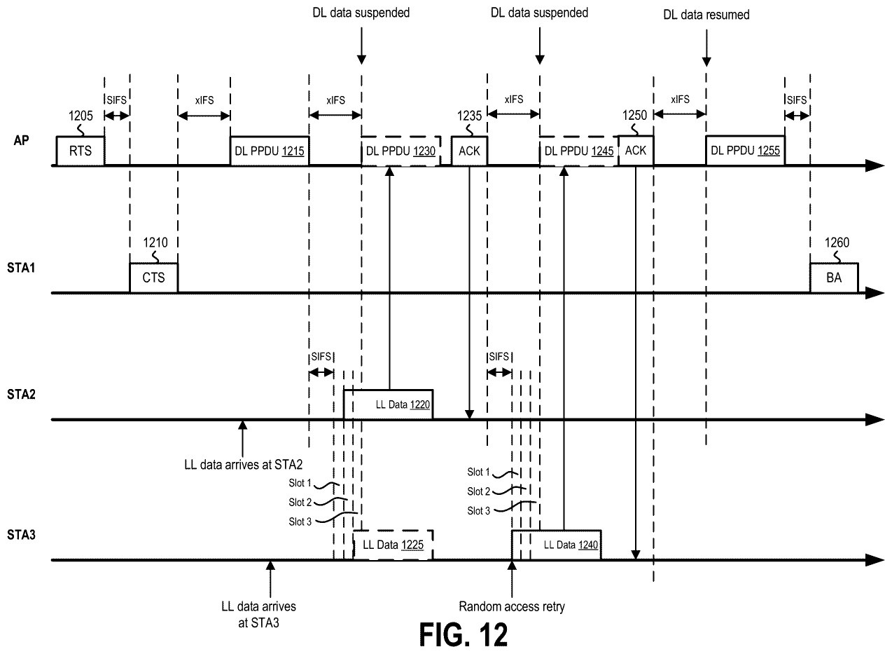

FIG. 12 is a diagram showing an example of transmitting low latency data using a slotted random access technique, according to some embodiments.

As shown in the diagram, the AP may transmit a RTS frame 1205 to STA1. Following a SIFS interval after receiving RTS frame 1205, STA1 may transmit a CTS frame 1210 to the AP. The exchange of the RTS frame 1205 and the CTS frame 1210 may establish a TXOP for the AP. The AP is said to be the TXOP holder in this scenario.

Following a xIFS interval after receiving CTS frame 1210, the AP may transmit fragmented DL PPDU 1215 to STA1.

STA2 may determine it has low latency data to transmit to the AP (LL data arrives at STA2) while the AP is transmitting fragmented DL PPDU 1215. Also, STA3 may also determine that it has low latency data to transmit to the AP (LL data arrives at STA3) while the AP is transmitting fragmented DL PPDU 1215.

STA2 and STA3 may each randomly select a slot in which to attempt to transmit its low latency data. In this example, the slot window includes three slots (N=3) and STA2 randomly selects slot 2 and STA3 randomly selects slot 3. As such, STA2 is able to transmit low latency data frame 1220 to the AP during slot 2 and STA3's attempt to transmit low latency data frame 1225 fails (as depicted in the diagram using dashed lines). In this example, STA2 randomly selects an earlier slot compared to STA3, and thus obtains a low latency data transmission opportunity. In an embodiment, each slot is assigned a different slot index (e.g., slot 1 is assigned slot index 1, slot 2 is assigned slot index 2, and slot 3 is assigned slot index 3), and a STA that has low latency data to transmit (e.g., STA2 or STA3) randomly selects a slot based on randomly selecting a slot index. In an embodiment, the number of slots included in the slot window may be different for different STAs depending on the priority of the STA's low latency data. In an embodiment, STAs obtain information regarding the number of slots included in the slot window from a frame transmitted by the AP during a link reservation process (e.g., during a RTS/CTS frame exchange).

The AP may suspend its transmission of the next scheduled fragmented DL PPDU 1230 to receive low latency data frame 1220. If the AP successfully receives low latency data frame 1220, the AP may transmit ACK frame 1235 to STA2 to acknowledge successful reception of low latency data frame 1220.

STA3 still has low latency data to transmit to the AP because it was not able to obtain a low latency data transmission opportunity during the xIFS interval. Thus, STA3 may again randomly select a slot and attempt to transmit its low latency data during the randomly selected slot in the next xIFS interval. In this example, it is assumed that STA3 randomly selects slot 1. As such, STA3 attempts to transmit low latency data frame 1240 to the AP during slot 1, which is successful this time (e.g., because STA3 randomly selected the earliest slot in the slot window and no other STA attempted to transmit low latency data during that slot).

The AP may suspend its transmission of the next scheduled fragmented DL PPDU 1245 to receive low latency data frame 1240. If the AP successfully receives low latency data frame 1240, the AP may transmit ACK frame 1250 to STA3 to acknowledge successful reception of low latency data frame 1240.

Following a xIFS interval after transmitting ACK frame 1250, the AP may resume transmitting fragmented PPDUs to STA1. For example, the AP may transmit fragmented DL PPDU 1255 to STA1. Fragmented DL PPDU 1255 may include the data that was supposed to be included in fragmented DL PPDU 1230 (and fragmented DL PPDU 1245) but that was not transmitted due to the AP's transmission being preempted by STA2 (and again being preempted by STA3). Following a SIFS interval after receiving the last fragmented DL PPDU from the AP, which in this example is fragmented DL PPDU 1255, STA1 may transmit a block ACK (BA) frame 1260 to the AP to acknowledge successful reception of all of the fragmented PPDUs.

In general, the longer the durationof the fragmented PPDUs transmitted by the TXOP holder, the longer the latency of the low latency data transmission because the STA that wishes to transmit low latency data must refrain from transmitting while the TXOP holder transmits a fragmented PPDU. Also, in general, the longer the slot window, the longer the xIFS interval has to be. Thus, a longer slot window may lower the overall throughput for the TXOP holder's transmissions. In view of this, network performance may be optimized by adjusting the duration of fragmented PPDUs and the duration of the slot window (and the duration of xIFS) based on the network situation.

When multi-channel and multi-link transmissions are possible in the network, the AP and STA1 may occupy a TXOP and the AP may transmit fragmented PPDUs with multi-link or multi-channel bonding methods. In this case, a frequency resource random access technique may be used to reduce probability of collisions. With the frequency resource random access technique, STAs that have low latency data to transmit may randomly select a subchannel from among a plurality of subchannels and attempt a low latency transmission during a xIFS interval between fragmented PPDU transmission in the randomly selected subchannel. Unlike the slotted random access technique described above that randomly accesses the medium in the time domain, the frequency resource random access technique may randomly access the medium in the frequency domain.

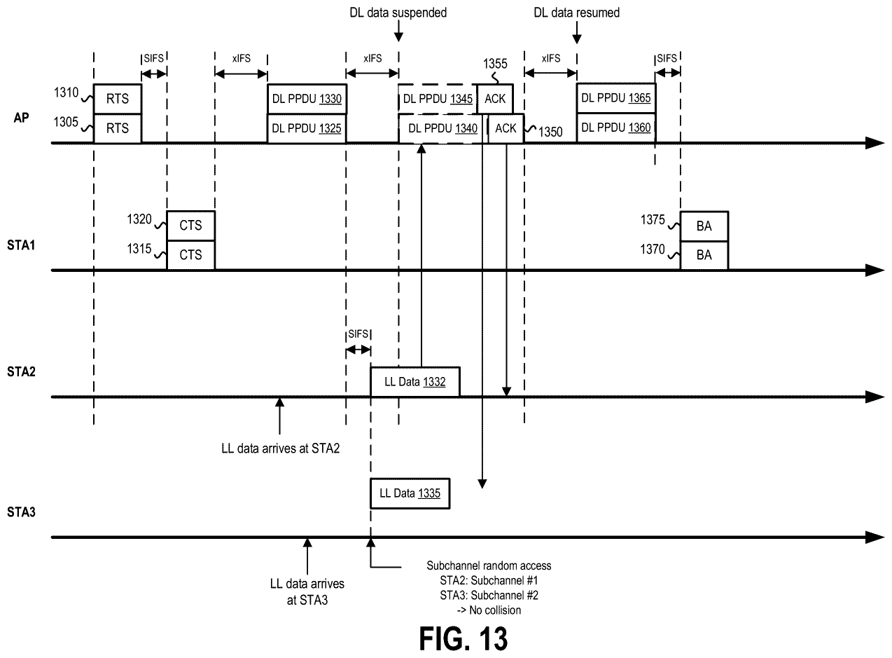

FIG. 13 is a diagram showing an example of transmitting low latency data using a frequency resource random access technique, where no collisions occur, according to some embodiments.

As shown in the diagram, the AP may simultaneously transmit RTS frame 1305 and RTS frame 1310 to STA in a first subchannel and a second channel, respectively. Following a SIFS interval after receiving RTS frames 1305 and 1310, STA1 may simultaneously transmit CTS frame 1315 and CTS frame 1320 to the AP in the first subchannel and the second channel, respectively. The exchange of the RTS frames 1310 and 1305 and the CTS frames 1315 and 1320 may establish a TXOP for the AP. The AP is said to be the TXOP holder in this scenario.

Following a xIFS interval after receiving CTS frames 1315 and 1320, the AP may simultaneously transmit fragmented DL PPDU 1325 and fragmented DL PPDU 1330 to STA1 in the first subchannel and the second subchannel, respectively. The simultaneous transmission of multiple fragmented PPDUs in multiple subchannels may be referred to as a fragmented multi-PPDU simultaneous transmission.

STA2 may determine it has low latency data to transmit to the AP (LL data arrives at STA2) while the AP is transmitting fragmented DL PPDU 1325 and fragmented DL PPDU 1330. Also, STA3 may also determine that it has low latency data to transmit to the AP (LL data arrives at STA3) while the AP is transmitting fragmented DL PPDU 1325 and fragmented DL PPDU 1330.

STA2 and STA3 may each randomly select a random subchannel in which to attempt to transmit its low latency data. In this example, there are two subchannels (the first subchannel and the second subchannel) and STA2 randomly selects the first subchannel and STA3 randomly selects the second subchannel. As such, following a SIFS interval after the AP finishes transmitting fragmented DL PPDUs 1325 and 1330, STA2 may transmit low latency data frame 1332 to the AP in the first subchannel and STA3 may transmit low latency data frame 1335 to the AP in the second subchannel. Since STA2 and STA3 transmit in different subchannels, a collision does not occur.

The AP may suspend its transmission of the next scheduled fragmented DL PPDUs 1340 and 1345 to receive low latency data frames 1332 and 1335 from STA2 and STA3, respectively. If the AP successfully receives low latency data frames 1332 and 1335, the AP may transmit ACK frame 1350 to STA2 in the first subchannel to acknowledge successful reception of low latency data frame 1332 and transmit ACK frame 1355 to STA3 in the second subchannel to acknowledge successful reception of low latency data frame 1335.

Following a xIFS interval after transmitting ACK frame 1350, the AP may resume transmitting fragmented PPDUs to STA1. For example, the AP may simultaneously transmit fragmented DL PPDU 1360 and fragmented DL PPDU 1365 to STA1 in the first subchannel and the second subchannel, respectively. Fragmented DL PPDU 1360 and fragmented DL PPDU 1365 may include the data that was supposed to be included in fragmented DL PPDU 1340 and fragmented DL PPDU 1345 but that was not transmitted due to the AP's transmission being preempted by STA2 and STA3. Following a SIFS interval after receiving the last fragmented DL PPDUs from the AP, which in this example are fragmented DL PPDU 1360 and fragmented DL PPDU 1365, STA1 may simultaneously transmit block ACK (BA) frame 1370 and block ACK frame 1375 to the AP in the first subchannel and the second subchannel, respectively, to acknowledge successful reception of all of the fragmented PPDUs.

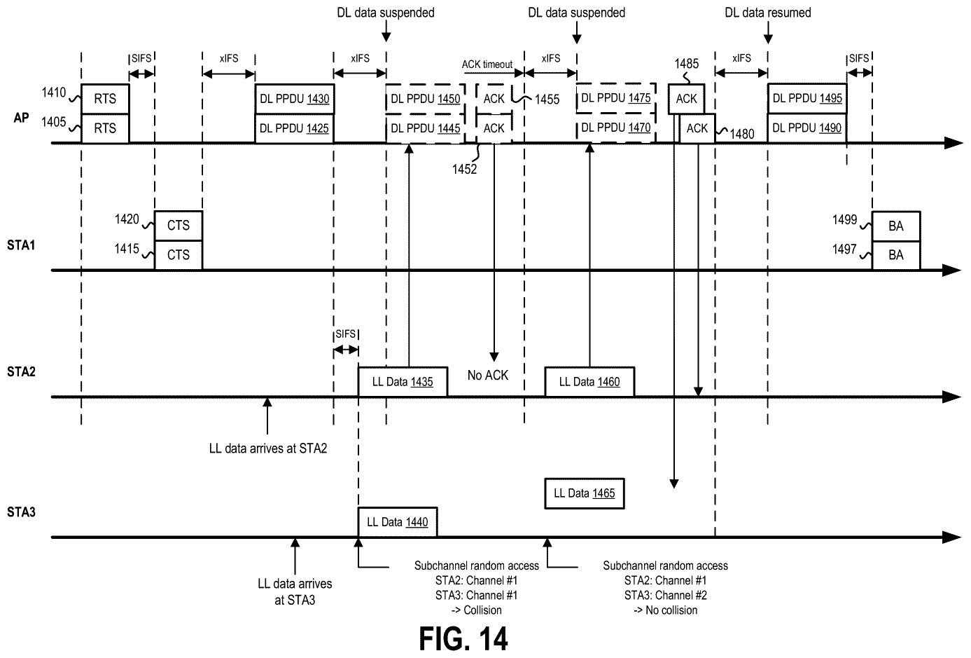

FIG. 14 is a diagram showing an example of transmitting low latency data using a frequency resource random access technique, where a collision occurs, according to some embodiments.

As shown in the diagram, the AP may simultaneously transmit RTS frame 1405 and RTS frame 1410 to STA1 in a first subchannel and a second channel, respectively. Following a SIFS interval after receiving RTS frames 1405 and 1410, STA1 may simultaneously transmit CTS frame 1415 and CTS frame 1420 to the AP in the first subchannel and the second channel, respectively. The exchange of the RTS frames 1410 and 1405 and the CTS frames 1415 and 1420 may establish a TXOP for the AP. The AP is said to be the TXOP holder in this scenario.

Following a xIFS interval after receiving CTS frames 1415 and 1420, the AP may simultaneously transmit fragmented DL PPDU 1425 and fragmented DL PPDU 1430 to STA1 in the first subchannel and the second subchannel, respectively.

STA2 may determine it has low latency data to transmit to the AP (LL data arrives at STA2) while the AP is transmitting fragmented DL PPDU 1425 and fragmented DL PPDU 1430. Also, STA3 may also determine that it has low latency data to transmit to the AP (LL data arrives at STA3) while the AP is transmitting fragmented DL PPDU 1425 and fragmented DL PPDU 1430.

STA2 and STA3 may each randomly select a random subchannel in which to attempt to transmit its low latency data. In this example, there are two subchannels (the first subchannel and the second subchannel) and both STA2 and STA3 randomly select the first subchannel. As such, following a SIFS interval after the AP finishes transmitting fragmented DL PPDUs 1425 and 1430, both STA2 and STA3 may attempt to transmit their low latency data frames (low latency data frame 1435 and low latency data frame 1440, respectively) to the AP in the first subchannel. Since STA2 and STA3 attempt to transmit in the same subchannel (the first subchannel), a collision occurs.

The AP may suspend its transmission of the next scheduled fragmented DL PPDUs 1445 and 1450 to receive the low latency data frames, but the AP may not be able to successfully receive either of the low latency data frame due to the occurrence of a collision. As a result, the AP may not transmit ACK frame 1452 or ACK frame 1455 to the STAs (these ACK frames are shown in dashed lines to indicate that they are not transmitted).

Since STA2 and STA3 did not receive an ACK frame from the AP, they may attempt to retransmit their low latency data during the next xIFS interval. For this purpose, STA2 and STA3 may again each randomly select a subchannel in which to attempt to transmit its low latency data. This time, in this example, STA2 randomly selects the first subchannel and STA3 randomly selects the second subchannel. As such, following a SIFS interval after the ACK timeout occurs, STA2 may attempt to transmit low latency data frame 1460 to the AP in the first subchannel and STA3 may attempt to transmit low latency data frame 1465 to the AP in the second subchannel.

The AP may suspend its transmission of the next scheduled fragmented DL PPDUs 1470 and 1475 to receive the low latency data frames. If the AP successfully receives low latency data frames 1460 and 1465, the AP may transmit ACK frame 1480 to STA2 in the first subchannel to acknowledge successful reception of low latency data frame 1460 and transmit ACK frame 1485 to STA3 in the second subchannel to acknowledge successful reception of low latency data frame 1465. In this example, no collision occurs because the low latency data frames are transmitted in different subchannels.

Following a xIFS interval after transmitting ACK frame 1480, the AP may resume transmitting fragmented PPDUs to STA1. For example, the AP may simultaneously transmit fragmented DL PPDU 1490 and fragmented DL PPDU 1495 to STA1 in the first subchannel and the second subchannel, respectively. Fragmented DL PPDU 1490 and fragmented DL PPDU 1495 may include the data that was supposed to be included in fragmented DL PPDU 1445 and fragmented DL PPDU 1450 (and also fragmented DL PPDU 1470 and fragmented DL PPDU 1475) but that was not transmitted due to the AP's transmission being preempted by STA2 and STA3.

Following a SIFS interval after receiving the last fragmented DL PPDUs from the AP, which in this example are fragmented DL PPDU 1490 and fragmented DL PPDU 1495, STA1 may simultaneously transmit block ACK (BA) frame 1497 and block ACK frame 1499 to the AP in the first subchannel and the second subchannel, respectively, to acknowledge successful reception of all of the fragmented PPDUs.

In this way, when using an inter-PPDU based preemption in an environment where there are multiple subchannels available for transmission, random access can be made in the frequency domain to reduce the probability of collisions. In an embodiment, instead of random access, the AP assigns frequency resource units (e.g., subchannels) in which STAs are allowed to transmit low latency data (e.g., when the STA associated with the AP or when the STA is about to transmit low latency data).

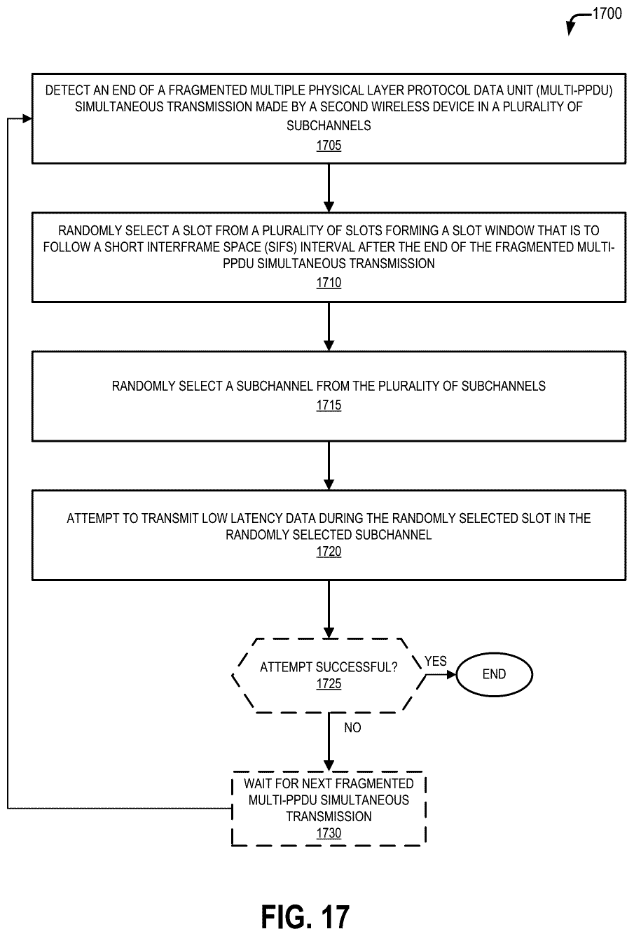

In an embodiment, the slotted random access technique and the frequency resource random access technique described herein can be combined to achieve more randomness, thereby further reducing the probability of collisions. Example operations for combining the two techniques are shown in FIG. 17 and described in relation thereto.

The slotted random access technique and/or the frequency resource random access technique described herein can be used to reduce the probability of collisions when there are multiple STAs that wish to transmit low latency data using an inter-PPDU preemption technique. By reducing the probability of collisions, network throughput can be increased and the latency of low latency transmissions can be reduced in situations where there are multiple STAs that wish to transmit low latency data.

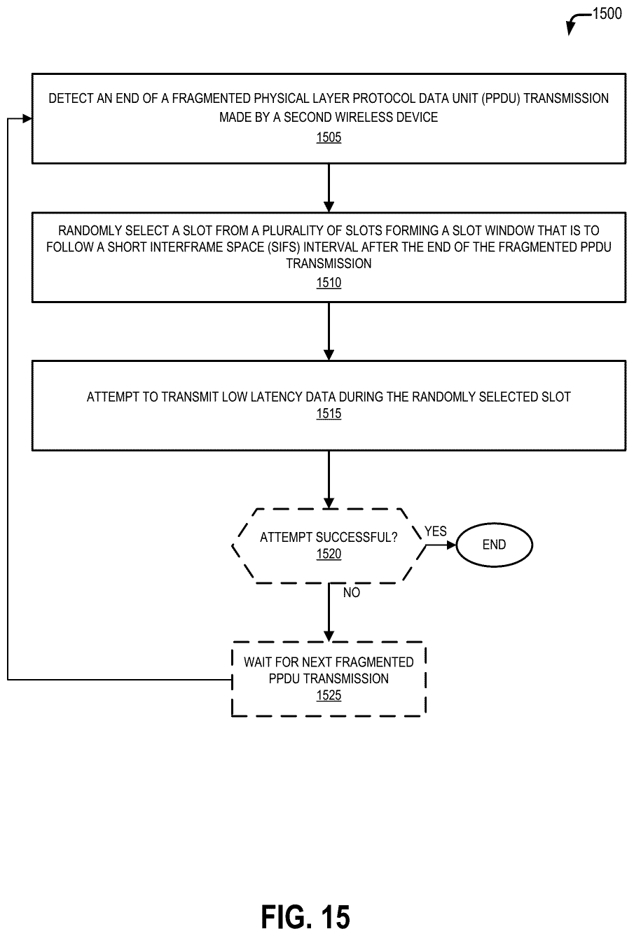

Turning now to FIG. 15, a method 1500 will be described for transmitting low latency data using a slotted random access technique, in accordance with an example embodiment. The method 1500 may be performed by a first wireless device in a wireless network. The first wireless device may have components similar to wireless device 104.

Additionally, although shown in a particular order, in some embodiments the operations of the method 1500 (and the other methods shown in the other figures) may be performed in a different order. For example, although the operations of the method 1500 are shown in a sequential order, some of the operations may be performed in partially or entirely overlapping time periods.

At operation 1505, the first wireless device detects an end of a fragmented PPDU transmission made by a second wireless device.

At operation 1510, the first wireless device randomly selects a slot from a plurality of slots forming a slot window that is to follow a SIFS interval after the end of the PPDU transmission. In an embodiment, a combined duration of the SIFS interval and the slot window is shorter than a predefined interframe space (xIFS) interval that is used by the second wireless device between PPDU transmissions. In an embodiment, the selected slot is randomly selected based on randomly selecting a slot index from a plurality of slot indices, wherein each of the plurality of slots is assigned a different one of the plurality of slot indices. In an embodiment, the first wireless device obtains information regarding a number of slots included in the slot window from a frame transmitted by the second wireless device during a link reservation process (e.g., during a RTS/CTS frame exchange). In an embodiment, a number of slots included in the slot window depends on a priority of the low latency data.

At operation 1515, the first wireless device attempts to transmit low latency data during the randomly selected slot. In an embodiment, the fragmented PPDU transmission is part of a fragmented multiple PPDU (multi-PPDU) simultaneous transmission made by the second wireless device in a plurality of subchannels. In such an embodiment, the first wireless device may randomly select a subchannel from the plurality of subchannels, wherein the attempt to transmit the low latency data is made in the randomly selected subchannel.

In an embodiment, at operation 1520, the first wireless device determines whether the attempt to transmit the low latency data was successful. If the attempt to transmit the low latency data was successful, the method may end. Otherwise, if the attempt to transmit the low latency data was unsuccessful, at operation 1525, the first wireless device may wait for the next fragmented PPDU transmission to be made by the second wireless device. The first wireless device may then repeat operations 1505-1515 for the next fragmented PPDU transmission. For example, the first wireless device may attempt to transmit the low latency data during a next slot window that follows a SIFS interval after an end of a next fragmented PPDU transmission made by the second wireless device.

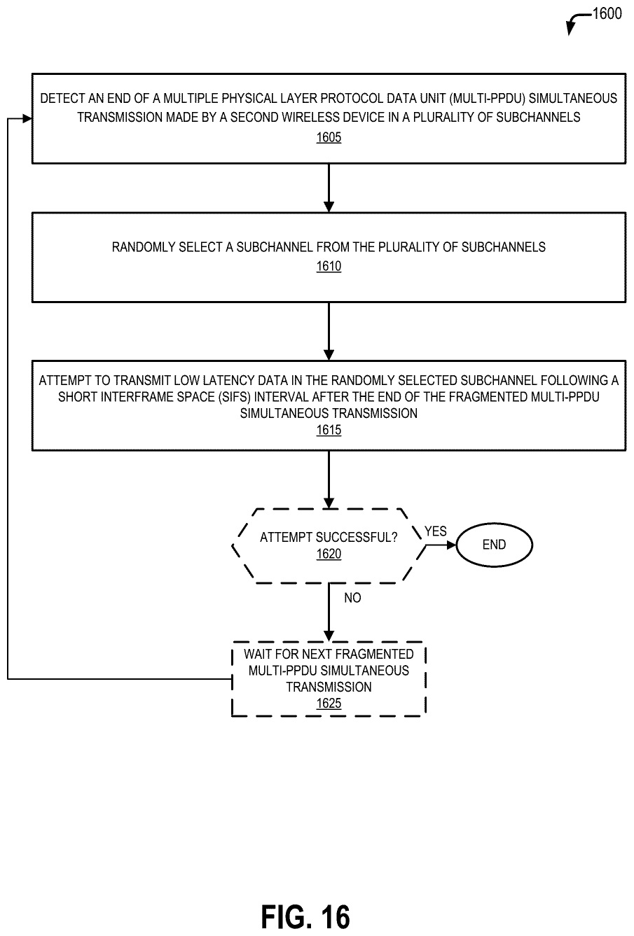

Turning now to FIG. 16, a method 1600 will be described for transmitting low latency data using a frequency resource random access technique, in accordance with an example embodiment. The method 1600 may be performed by a first wireless device in a wireless network. The first wireless device may have components similar to wireless device 104.

At operation 1605, the first wireless device detects an end of a fragmented multiple physical layer protocol data unit (multi-PPDU) simultaneous transmission made by a second wireless device in a plurality of subchannels. In an embodiment, the second wireless device uses a predefined interframe space (xIFS) interval between fragmented multi-PPDU simultaneous transmissions, wherein preemption is allowed during the xIFS interval and a duration of the xIFS interval is longer than a duration of the SIFS interval.

At operation 1610, the first wireless device randomly selects a subchannel from the plurality of subchannels.

At operation 1615, the first wireless device attempts to transmit low latency data in the randomly selected subchannel following a SIFS interval after the end of the fragmented multi-PPDU simultaneous transmission.

At operation 1620, the first wireless device determines whether the attempt to transmit the low latency data was successful. If the attempt to transmit the low latency data was successful, the method may end. Otherwise, if the attempt to transmit the low latency data was unsuccessful, at operation 1625, the first wireless device may wait for the next fragmented multi-PPDU simultaneous transmission to be made by the second wireless device. The first wireless device may then repeat operations 1605-1615 for the next fragmented multi-PPDU simultaneous transmission. For example, the first wireless device may attempt to transmit the low latency data in a randomly selected subchannel following a SIFS interval after an end of the next fragmented multi-PPDU simultaneous transmission made by the second wireless device.

In an embodiment, the first wireless device receives an ACK frame from the second wireless device in the randomly selected subchannel that acknowledges the low latency data.

Turning now to FIG. 17, a method 1700 will be described for transmitting low latency data using a combination of a slotted random access technique and a frequency resource random access technique, in accordance with an example embodiment. The method 1700 may be performed by a first wireless device in a wireless network. The first wireless device may have components similar to wireless device 104.

At operation 1705, the first wireless device detects an end of a fragmented multi-PPDU simultaneous transmission made by a second wireless device in a plurality of subchannels.

At operation 1710, the first wireless device randomly selects a slot from a plurality of slots forming a slot window that is to follow a SIFS interval after the end of the fragmented multi-PPDU simultaneous transmission.

At operation 1715, the first wireless device randomly selects a subchannel from the plurality of subchannels.

At operation 1720, the first wireless device attempts to transmit low latency data during the randomly selected slot in the randomly selected subchannel.

In an embodiment, at operation 1725, the first wireless device determines whether the attempt to transmit the low latency data was successful. If the attempt to transmit the low latency data was successful, then the method may end. Otherwise, if the attempt to transmit the low latency data was unsuccessful, at operation 1730, the first wireless device may wait until the next fragmented multi-PPDU simultaneous transmission to be made by the second wireless device. The first wireless device may then repeat operations 1705-1720 for the next fragmented multi-PPDU simultaneous transmission.

Although many of the solutions and techniques provided herein have been described with reference to a WLAN system, it should be understood that these solutions and techniques are also applicable to other network environments, such as cellular telecommunication networks, wired networks, etc. In some embodiments, the solutions and techniques provided herein may be or may be embodied in an article of manufacture in which a non-transitory machine-readable medium (such as microclectronic memory) has stored thereon instructions which program one or more data processing components (generically referred to here as a “processor” or “processing unit”) to perform the operations described herein. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In some cases, an embodiment may be an apparatus (e.g., an AP STA, a non-AP STA, or another network or computing device) that includes one or more hardware and software logic structures for performing one or more of the operations described herein. For example, as described herein, an apparatus may include a memory unit, which stores instructions that may be executed by a hardware processor installed in the apparatus. The apparatus may also include one or more other hardware or software elements, including a network interface, a display device, etc.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system may carry out the computer-implemented methods described herein in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method performed by a first wireless device to transmit low latency data using a slotted random access technique, comprising:
detecting an end of a fragmented physical layer protocol data unit (PPDU) transmission made by a second wireless device;
randomly selecting a slot from a plurality of slots forming a slot window that is to follow a short interframe space (SIFS) interval after the end of the fragmented PPDU transmission; and
attempting to transmit low latency data during the randomly selected slot.

2. The method of claim 1, wherein a combined duration of the SIFS interval and the slot window is shorter than a predefined interframe space (xIFS) interval that is used by the second wireless device between fragmented PPDU transmissions.

3. The method of claim 1, further comprising:
responsive to determining that the attempt to transmit the low latency data was unsuccessful, attempting to transmit the low latency data during a next slot window that follows a SIFS interval after an end of a next fragmented PPDU transmission made by the second wireless device.

4. The method of claim 3, wherein the selected slot is randomly selected based on randomly selecting a slot index from a plurality of slot indices, wherein each of the plurality of slots is assigned a different one of the plurality of slot indices.

5. The method of claim 4, further comprising:
obtaining information regarding a number of slots included in the slot window from a frame transmitted by the second wireless device during a link reservation process.

6. The method of claim 1, wherein a number of slots included in the slot window depends on a priority of the low latency data.

7. The method of claim 1, wherein the fragmented PPDU transmission is part of a fragmented multiple PPDU (multi-PPDU) simultaneous transmission made by the second wireless device in a plurality of subchannels, wherein the method further comprises:
randomly selecting a subchannel from the plurality of subchannels, wherein the attempt to transmit the low latency data is made in the randomly selected subchannel.

8. A method performed by a wireless device to transmit low latency data using a frequency resource random access technique, the method comprising:
detecting an end of a fragmented multiple physical layer protocol data unit (multi-PPDU) simultaneous transmission made by a second wireless device in a plurality of subchannels;
randomly selecting a subchannel from the plurality of subchannels; and
attempting to transmit low latency data in the randomly selected subchannel following a short interframe space (SIFS) interval after the end of the fragmented multi-PPDU simultaneous transmission.

9. The method of claim 8, wherein the second wireless device uses a predefined interframe space (xIFS) interval between fragmented multi-PPDU simultaneous transmissions, wherein preemption is allowed during the xIFS interval and a duration of the xIFS interval is longer than a duration of the SIFS interval.

10. The method of claim 8, further comprising:
responsive to determining that the attempt to transmit the low latency data was unsuccessful, attempting to transmit the low latency data in a randomly selected subchannel following a SIFS interval after an end of a next fragmented multi-PPDU simultaneous transmission made by the second wireless device.

11. The method of claim 8, further comprising:
receiving an acknowledgement (ACK) frame from the second wireless device in the randomly selected subchannel that acknowledges the low latency data.

12. A first wireless device configured to transmit low latency data using a slotted random access technique, the first wireless device comprising:
a radio frequency transceiver;
a memory device storing a set of instructions; and
a processor coupled to the memory device, wherein the set of instructions when executed by the processor causes the first wireless device to:
detect an end of a fragmented physical layer protocol data unit (PPDU) transmission made by a second wireless device;
randomly select a slot from a plurality of slots forming a slot window that is to follow a short interframe space (SIFS) interval after the end of the fragmented PPDU transmission; and
attempt to transmit low latency data during the randomly selected slot.

13. The first wireless device of claim 12, wherein a combined duration of the SIFS interval and the slot window is shorter than a predefined interframe space (xIFS) interval that is used by the second wireless device between fragmented PPDU transmissions.

14. The first wireless device of claim 12, wherein the set of instructions when executed by the processor further causes the first wireless device to:
responsive to determining that the attempt to transmit the low latency data was unsuccessful, attempting to transmit the low latency data during a next slot window that follows a SIFS interval after an end of a next fragmented PPDU transmission made by the second wireless device.

15. The first wireless device of claim 12, wherein the selected slot is randomly selected based on randomly selecting a slot index from a plurality of slot indices, wherein each of the plurality of slots is assigned a different one of the plurality of slot indices.

16. The first wireless device of claim 12, wherein the fragmented PPDU transmission is part of a fragmented multiple PPDU (multi-PPDU) simultaneous transmission made by the second wireless device in a plurality of subchannels, wherein the set of instructions when executed by the processor further causes the first wireless device to:
randomly selecting a subchannel from the plurality of subchannels, wherein the attempt to transmit the low latency data is made in the randomly selected subchannel.

17. A first wireless device configured to transmit low latency data using a frequency resource random access technique, the first wireless device comprising:
a radio frequency transceiver;
a memory device storing a set of instructions; and
a processor coupled to the memory device, wherein the set of instructions when executed by the processor causes the first wireless device to:
detect an end of a fragmented multiple physical layer protocol data unit (multi-PPDU) simultaneous transmission made by a second wireless device in a plurality of subchannels;
randomly select a subchannel from the plurality of subchannels; and
attempt to transmit low latency data in the randomly selected subchannel following a short interframe space (SIFS) interval after the end of the fragmented multi-PPDU simultaneous transmission.

18. The first wireless device of claim 17, wherein the second wireless device uses a predefined interframe space (xIFS) interval between fragmented multi-PPDU simultaneous transmissions, wherein preemption is allowed during the xIFS interval and a duration of the xIFS interval is longer than a duration of the SIFS interval.

19. The first wireless device of claim 17, wherein the set of instructions when executed by the processor further causes the first wireless device to:
responsive to determining that the attempt to transmit the low latency data was unsuccessful, attempting to transmit the low latency data in a randomly selected subchannel following a SIFS interval after an end of a next fragmented multi-PPDU simultaneous transmission made by the second wireless device.

20. The first wireless device of claim 17, wherein the set of instructions when executed by the processor further causes the first wireless device to:
receive an acknowledgement (ACK) frame from the second wireless device in the randomly selected subchannel that acknowledges the low latency data.
